(19) United States
(12) Patent Application Publication
(10) Pub. No.: US 2015/0190217 A1
(43) Pub. Date: Jul. 9, 2015

(54) DENTAL HYGIENE ITEM

(71) Applicant: ERSKINE PRODUCTS PTY LTD., North Curl Curl, New South Wales (AU)

(72) Inventor: Craig Mathew Erskine-Smith, North Curl Curl (AU)

(21) Appl. No.: 14/367,713

(22) PCT Filed: Dec. 21, 2012
(86) PCT No.: PCT/AU2012/001585

§ 371 Date: Jun. 20, 2014

(30) Foreign Application Priority Data
Dec. 23, 2011 (AU) 2011905437

(51) Int. Cl. A61C 15/04; A46B 5/00

(52) U.S. Cl. CPC A61C 15/048; A46B 5/0095

(57) ABSTRACT

A dental hygiene item such as an interdental brush (10) and a floss item (30). The items (10 and 30) are intended to be used with a handle (50) to aid in manipulating the item. Each of the items has a second end portion such as a second end portion (40) that is received within the handle (50).

### FIELD

The present invention relates to dental hygiene items and more particularly but not exclusively to dental hygiene items such as brushes, including tooth brushes, floss items and interdental brushes.

### BACKGROUND

Most oral hygiene appliances require the use of a manually claspable handle. Such handle can be further defined as of the manual, non electric variety, wherein the user provides muscle power creating a scrubbing action which transmits through to the working end of the device. Alternatively, the handle can be powered electrically and engineered to create sub-sonic, sonic or ultrasonic vibrations in the device, or it can provide a mechanised scrubbing action in the device by means of small electric motors, driveshafts and appropriate gearing. All handles that provide either a macro mechanical or a micro-mechanical scrubbing action, whether it be via driveshafts and gearboxes or via sonically induced vibrations or simple mechanically generated vibrations, or sonic or ultrasonic or subsonic vibrations or movements induced by an eccentric weight on a rotating electric motor shaft shall hereafter be referred to as electric handles.

In order to conserve plastic and provide greater economy to the user, some manufacturers have developed replaceable heads for manual toothbrushes so that the full handle is not thrown away when the brush head is worn out. In a similar vein, others have developed replaceable flossing devices similar to the replaceable brush head concept, where a plastic fork is overmoulded over a section of floss, and this plastic device is fitted onto a handle, which can be manual or electric, in order to make flossing easier. Whilst it is comparatively unusual to see a manual brush with a replaceable head, nearly all electric brush handles have replaceable heads as it would be economically and environmentally unsustainable to throw away the whole electric apparatus when the brush was worn out.

Many manufacturers have developed extension handles for interdental brushes. Such brushes fall into three types—1) those which are themselves equipped with usable mini or small handles usually overmoulded or glued or welded to the twisted wire, 2) those with small plastic retention devices which attach to a corresponding receptacle in a larger handle, or 3) those that have a simple twisted wire brush with no inbuilt mini handle or retention device, where such wire directly clips into or attaches to a large toothbrush like handle that has been specifically designed to accept plain interdental brush twisted wire heads, thus saving the cost of overmoulding a new handle, or the waste of throwing away the plastic handle every time an interdental brush is used.

Many manufacturers have developed stain removal devices which have their own unique handle, and which is permanently attached to and thrown away with the device head when only the device head is worn out This is a waste of the plastic handle, and a waste of plastic, which is usually derived from oil, a resource that has both a limited future availability and likely substantial future cost increase, and should be conserved where possible and reasonable. Similarly, many manufacturers have denture brushes, which have their own unique (large) handle and which is permanently attached to and thrown away with the device head. Similarly, many manufacturers have developed a so-called single tuft brush heads, which often actually may consist of a series of small tufts focused into a tip to give higher cleaning power to specialised areas which also have a permanently attached handle. Similarly, many manufacturers have tongue scrapers that have integrally attached handles.

The different devices used at the oral interface have vastly different requirements in terms of their orientation, fixation requirements, cross sectional strength and forces applied to the handle and through the connector. For example, most floss items and interdental brushes have low force requirements and therefore a simple mini handle stem will suffice, which simple mini handle stem enables the device to be used on its own without a toothbrush sized extension handle.

This is in contrast to devices such as a toothbrush that must have a substantial handle so that it is comfortable, durable and strong enough to transmit the forces required when using such a toothbrush, or a single tuft brush, a denture brush, or even possibly a stain remover.

In addition to the above, some of the devices that are inserted into the inside of any proposed brush handle connector will provide substantial rotational forces on the connector, which must be resisted so that the product can be used successfully without long axis or rotational slippage. An example of this would be an over moulded flossing device where the floss runs parallel with the handle but is offset. Therefore the force on the floss provides a torqueing action on the handle. This force goes through the connection device to the handle, and must be resisted at the connection point.

Most electric bush handles have male projections as an attachment apparatus and as a drive shaft which will allow for removable heads to be placed over them, however, these projections and the surface they form when they enter into the handle body make the entire apparatus completely unsuitable for use in the mouth without a brush fitted. The reason for this is these handles are designed to be used only with a brush head attached in position in order to smooth over the gross surface irregularities and to form a continuous smooth contour between the handle and the brush head. The profile created by the large ledge where the male projection enters into the body of the handle is completely unsuitable for rubbing across the lip without a brush head on the handle.

The handles are not designed for universal use with AND without a brush head, because they are not designed with smooth surfaces and contoured transitional angles to facilitate intra oral use without a brush head (or similar external head device such as a flosser) placed over the drive shaft/attachment apparatus. They also often have large external irritating projections designed as undercuts or retentive devices to engage and retain the brush head with a snap on action, which, if used or rubbed in the mouth would cause irritation to or trauma to the lip.

### OBJECT

It is an object of the present invention to overcome or substantially ameliorate at least one of the above disadvantages.

### SUMMARY

There is disclosed here a dental hygiene item, said item including:

a body having a longitudinal axis, and first and second longitudinally opposite end portions;

a mouth engaging part at said first end portion, the mouth engaging part being provided to engage a user's teeth or tongue; and wherein

said second end portion includes a set of first surfaces, the first surfaces at least partly facing transfers relative to said axis so that the surfaces aid a user to grip the body and to apply forces to the body; and said second end portion has an end extremity, with said body tapering towards said end extremity.

Preferably said second end includes a plurality of longitudinally extended slots that provide the first surfaces.

Preferably, said second end includes a plurality of angularly extending slots that provide said second surfaces.

Preferably the first surfaces are arranged in pairs, with the pairs of the first surfaces converging radially outward relative to said axis to a peak.

Preferably the peaks are arranged in sets, the sets being located at longitudinally spaced locations along said axis, and are arranged in angularly extending rows.

In one preferred form, said second end portion includes a set of second surfaces, the second surfaces at least partly facing longitudinally relative to said axis.

There is further disclosed herein, in combination, the above item and a handle, the handle including:

a gripping portion to be engaged by a user so that a user may apply forces and/or torque to said handle; and

a socket within which said second end is located when the items is reconnected to the handle.

Preferably said socket tapers inwardly of the handle.

Preferably said handle has an end extremity providing a surface with a radius.

### BRIEF DESCRIPTION OF THE DRAWINGS

A preferred form of the present invention will now be described by way of example with reference to accompanying drawings wherein:

FIG. 1 is an isometric view of an interdental brush and portion of a handle;

FIG. 2 is a schematic isometric view of a floss item;

FIG. 3 is schematic isometric view of the floss item of FIG. 2 applied to the handle of FIG. 1;

FIG. 4 is a schematic isometric view of the end portion of the interdental brush of FIG. 1;

FIG. 5 is a schematic end view of the end portion of FIG. 4;

FIG. 6 is a schematic isometric view of the end portion of the handle of FIGS. 1 and 3;

FIG. 7 is a schematic side elevation of the end portion of FIG. 6; and

FIG. 8 is a schematic section side elevation of the end portion of FIG. 7 section along the line 8-8;

FIG. 9 is a schematic isometric view of a modification of the floss item of FIG. 2;

FIG. 10 is a schematic side elevation of a modification of the end portion of the handle of FIGS. 6, 7 and 8; and

FIG. 11 is a schematic isometric view of the end portion of FIG. 10.

### DETAILED DESCRIPTION OF THE PREFERRED EMBODIMENTS

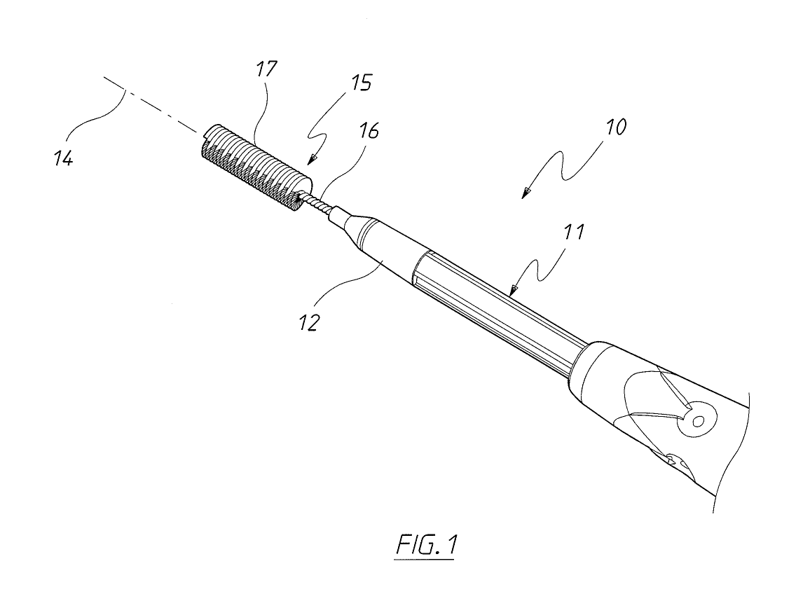

In FIG. 1 there is schematically depicted a dental hygiene item. In this particular embodiment the dental hygiene item is an interdental brush 10. The brush 10 includes an elongated body 11 that would be typically moulded from plastic material having a first end portion 12 and an opposite second end portion 13.

The body 11 has a longitudinal axis 14.

Secured to the end portion 12 is a brush 15. The brush 15 includes a twisted or otherwise formed wire base 16 to which there is secured a series a plurality of bristles 17 extending away from the base 16.

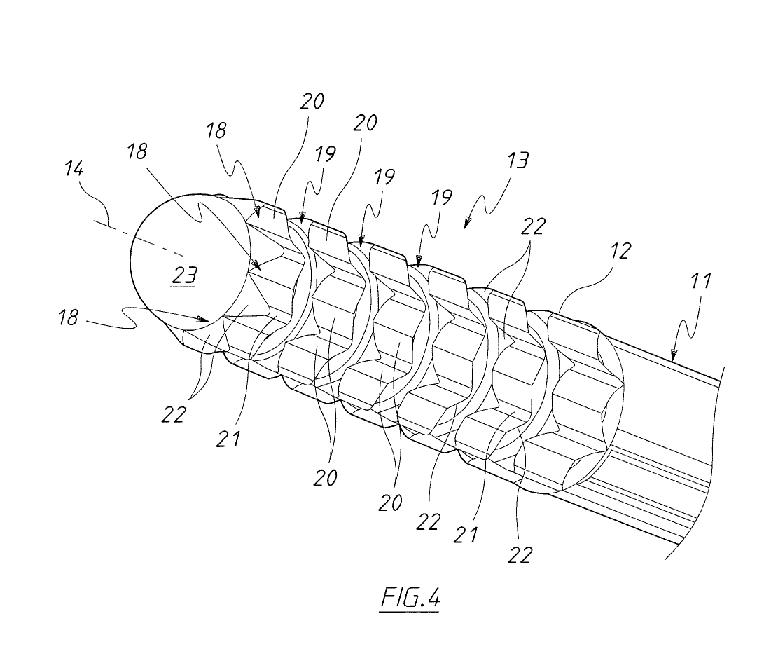

In FIG. 4, the end portion 12 includes a plurality of longitudinally extending slots 18 and a plurality of annular (annular extending) slots 19. The slots 19 are located at longitudinally space locations relative to the axis 14, while the slots 18 are located at angularly spaced locations about the axis 14.

The slots 18 cooperate to provide surfaces 20 that face at least partly transverse (angularly) about the axis 14, and more particularly face entirely angularly (transverse) about the axis 14. The surfaces 20 are arranged in pairs with each pair convergingly radially outwardly to an apex 21.

The angularly extending slots 19 provide surfaces 22 that are located at longitudinally spaced locations along the axis 14. The surfaces 22 face at least partly longitudinally relative to the axis 14, and more preferably partly longitudinally relative to the axis 14 and partly radially outward relative to the axis 14.

The end portion 13 in FIG. 4 has an end extremity 23, with the end portion 13 tapering inwardly towards the axis 14, that is towards the end extremity 23.

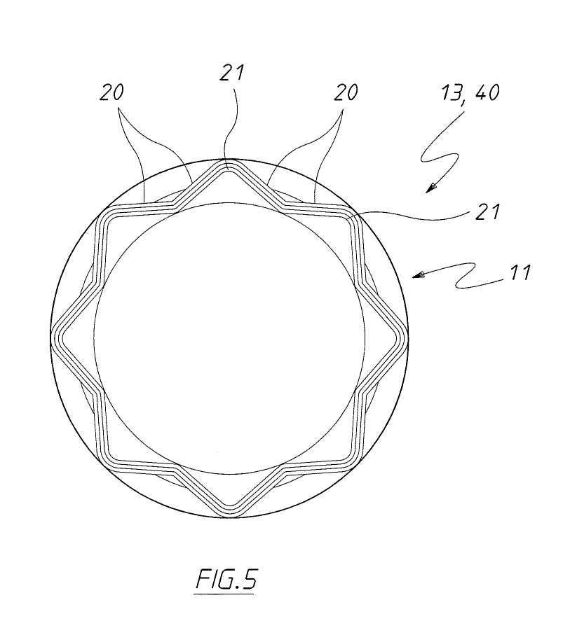

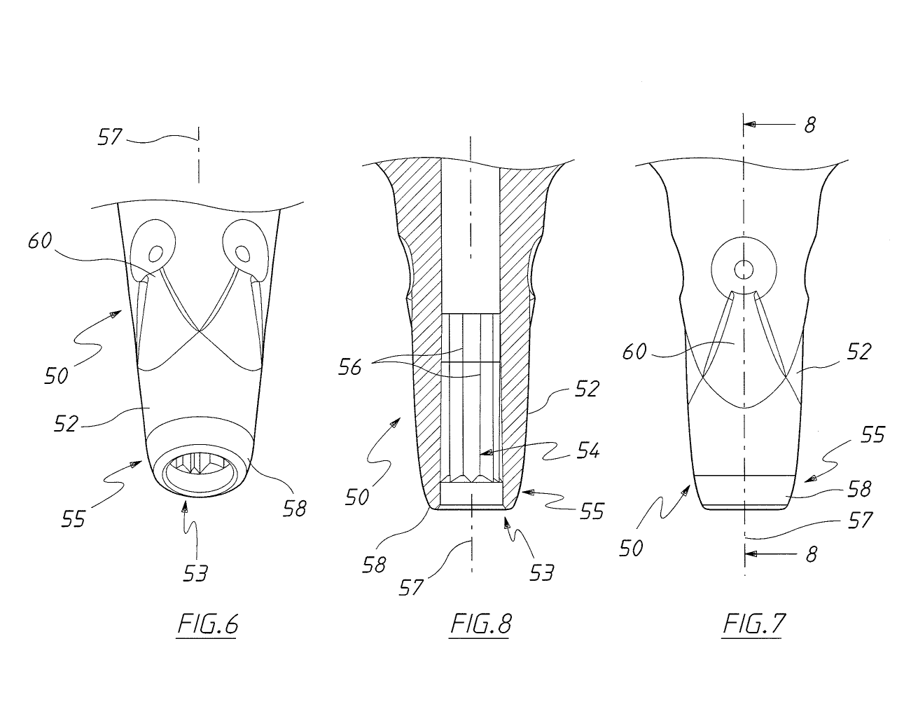

The above described preferred embodiment enables a user to grip the body 11 at end portion 13 and apply to the surfaces 20 and 22, forces longitudinal relative to the axis 14, forces transverse relative to the axis 14 as well as apply a torque angularly about the axis 14, as well as longitudinally lock in the tapered end portion 13 into a corresponding tapered socket 53 of FIG. 6, and to obtain an anti-rotation benefit by engaging the corresponding ridges 56 of FIG. 8.

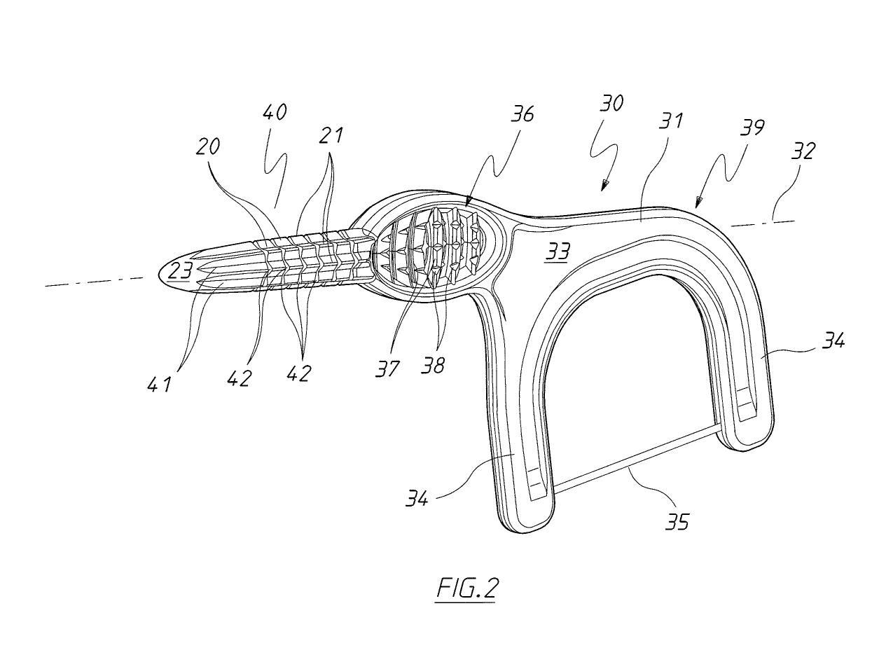

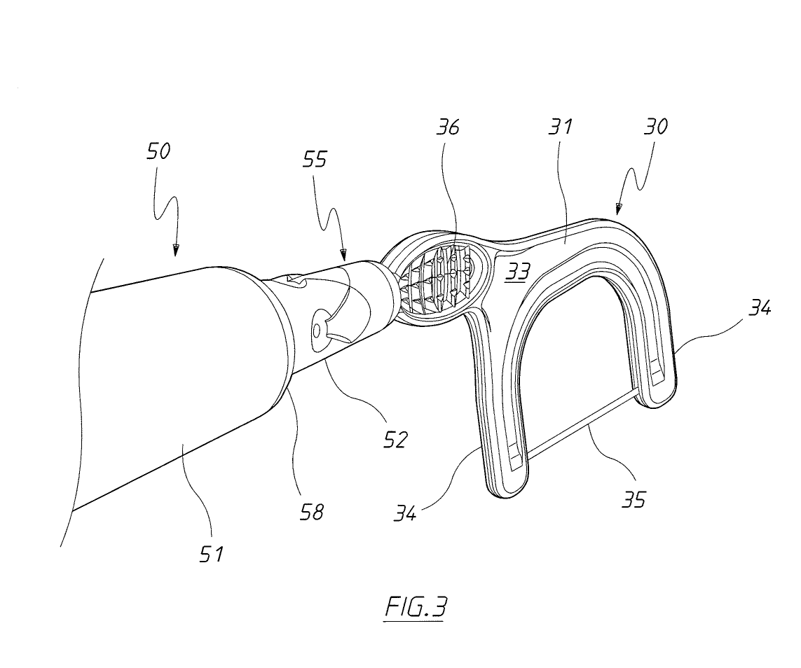

In the embodiment of FIG. 2 the dental hygiene item is a floss item 30. The item 30 has a body 31 providing a longitudinal axis 32. The body 31 has a base 33 from which there extends a pair of space but generally parallel to the arms 34. Extending between the end extremities of the arms 34 is a flossing tape 35 that may be tensioned.

The body 31 also has a first gripping portion 36 that provides a plurality of projections and ridges 37 and 38 that assist a user in gripping the item 30 so that a force can be applied thereto. The force may be longitudinal relative to the axis 32, and/or transverse relative to the axis 32 and/or may include a torque applied about the axis 32.

The body 33 has a first end portion 39 providing the arms 34 and a second end portion 40 which is substantially similar to the second end portion 13 of the embodiment of FIGS. 1 and 4. The second end portion 40 includes a plurality of longitudinally extending slots 41 that are spaced angularly about the axis 32, as well as a plurality of annular (angularly extending) slots 42 that are located at space locations longitudinally along the axis 32. These slots 41 and 42 cooperate to provide the surfaces 20 and 22 as described with references to FIG. 4. The end portion 40 also tapers toward the axis 32, as well as the end extremity 23. The end of portion 40 is adapted to be received within the socket 53 of FIG. 6 and FIG. 8 and to be used with the handle 50 of FIGS. 6, 7 and 8. Dental hygiene items 10 and 30 are useable with a handle 50. The handle 50 is to be gripped by a user so that a user may apply the forces and torque to the dental items as previously discussed.

The handle 50 includes a gripping portion that is gripped in the palm of a user's hand and can be engaged by user's fingers. As shown in FIGS. 6, 7 and 8, securely to and projecting forward of the gripping portion is an end portion 52 that provides a socket 53. The socket 53 includes a passage 54 that extends longitudinally inwardly of the end extremity 55. Surrounding the passage 54 is a plurality of longitudinally extending ridges 56. The ridges 56 are located at angularly spaced locations about the longitudinal axis 57 of the handle 50 and are configured to be received on the longitudinally extending spots 18 of the end portions 13 and 40. Preferably the passage 54 tapers inwardly from the end extremity 55 so that the end portions 13 and 40 can functionally engage within the socket 53 so that there is a secure connection between the handle 50 and the dental hygiene item such as the item 10 or the item 30, in addition to any external item secured over the external of portion 52. This secure connection includes being able to engage the dental hygiene item 10 or 30 so that forces may be applied longitudinally relative to the axis 14, 32 and 57 in either longitudinal direction, without the device disengaging and separating, or forces may be applied axially around axis 14, 32 or 57 with rotational slippage of the connection.

Preferably the end extremity 55 provides curve surface 58 to facilitate comfortable intraoral use.

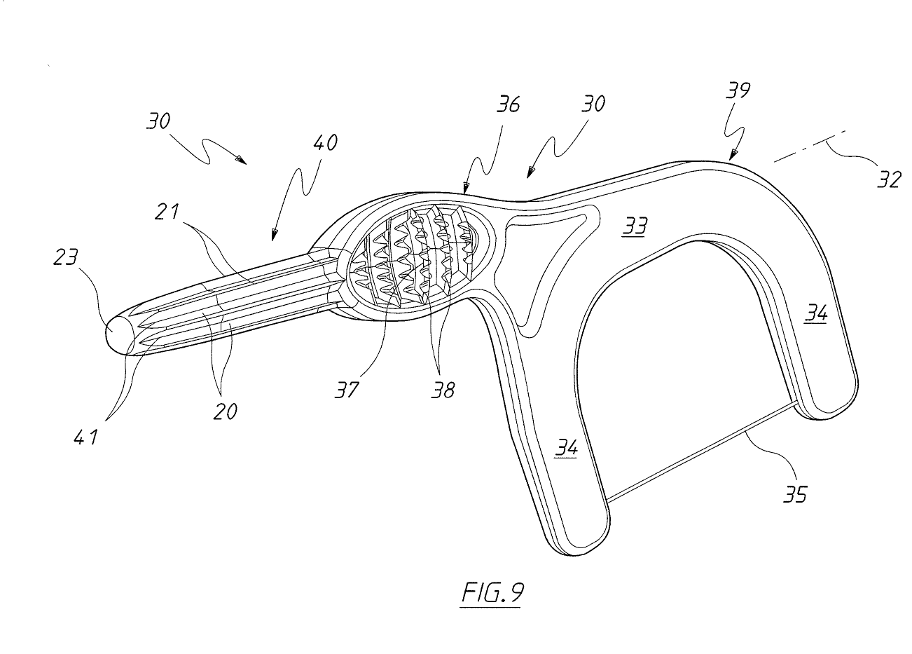

In the embodiment of FIG. 9, the floss item 30 only has longitudinally extending slots 19 so as to also have longitudinally extending apexes 21. Accordingly only longitudinally extending transversely facing surfaces 20 are provided.

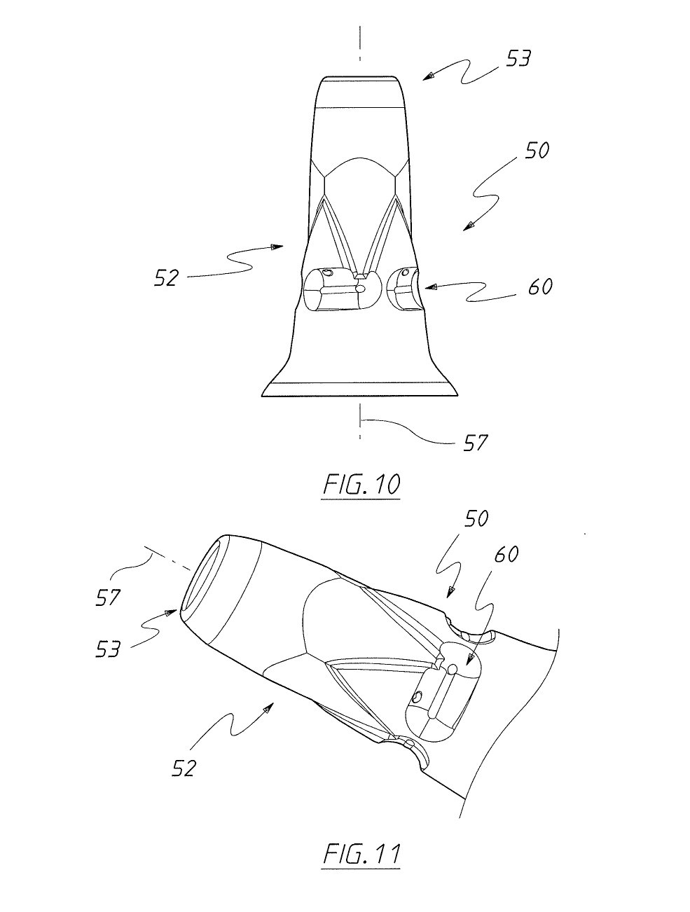

The end portion 52 of the embodiment of FIGS. 6 to 8 includes recesses 60 that enable the end portion 52 to engage other dental hygiene items. In the embodiments of FIGS. 6, 7 and 8, the recesses 60 mainly extend axially. In the embodiment of FIGS. 10 and 11, the recesses 60 also extend angularly about the axis 57.

In the above embodiments, relative longitudinal movement between the handle and head towards each other engages the end portion 40 in the socket 53.

1. A dental hygiene item, said item including:
a body having a longitudinal axis, and first and second longitudinally opposite end portions;
a mouth engaging part at said first end portion, the mouth engaging part being provided to engage a user's teeth or tongue; and wherein
said second end portion includes a set of first surfaces, the first surfaces at least partly facing transverse relative to said axis so that the surfaces aid a user to grip the body and to apply forces to the body; and said second end portion has an end extremity, with said body tapering towards said end extremity.

2. The dental hygiene item of claim 1, wherein said second end includes a plurality of longitudinally extended slots that provide the first surfaces.

3. The dental hygiene item of claim 1, wherein said second end includes a plurality of angularly extending slots that provide said second surfaces.

4. The dental hygiene item of claim 1, wherein the first surfaces are arranged in pairs, with the pairs of the first surfaces converging radially outward relative to said axis to a peak.

5. The dental hygiene item of claim 4, wherein the peaks are arranged in sets, the sets being located at longitudinally spaced locations along said axis, and are arranged in angularly extending rows.

6. The dental hygiene item of claim 1, wherein said second end portion includes a set of second surfaces, the second surfaces at least partly facing longitudinally relative to said axis.

7. In combination, the dental hygiene item of claim 1 and a handle, the handle including:
a gripping portion to be engaged by a user so that a user may apply forces and/or torque to said handle; and
a socket within which said second end is located when the items is reconnected to the handle.

8. The combination of claim 7, wherein said socket tapers inwardly of the handle.

9. The combination of claim 7, wherein said handle has an end extremity providing a surface with a radius.

10. The dental hygiene item of claim 2, wherein said second end includes a plurality of angularly extending slots that provide said second surfaces.

11. The dental hygiene item of claim 2, wherein the first surfaces are, arranged in pairs, with the pairs of the first surfaces converging radially outward relative to said axis to a peak.

12. The dental hygiene item of claim 11, wherein the peaks are arranged in sets, the sets being located at longitudinally spaced locations along said axis, and are arranged in angularly extending rows.

13. The dental hygiene item of claim 12, wherein said second end portion includes a set of second surfaces, the second surfaces at least partly facing longitudinally relative to said axis.

14. In combination, the dental hygiene item of claim 13, and a handle, the handle including:
a gripping portion to be engaged by a user so that a user may apply forces and/or torque to said handle; and
a socket within which said second end is located when the items is reconnected to the handle.

15. The combination of claim 14, wherein said socket tapers inwardly of the handle.

16. The combination of claim 15, wherein said handle has an end extremity providing a surface with a radius.

17. The dental hygiene item of claim 3, wherein the first surfaces are arranged in pairs, with the pairs of the first surfaces converging radially outward relative to said axis to a peak.

18. The dental hygiene item of claim 17, wherein the peaks are arranged in sets, the sets being located at longitudinally spaced locations along said axis, and are arranged in angularly extending rows.

19. The dental hygiene item of claim 18, wherein said second end portion includes a set of second surfaces, the second surfaces at least partly facing longitudinally relative to said axis.

20. In combination, the dental hygiene item of claim 19 and a handle, the handle including:
a gripping portion to be engaged by a user so that a user may apply forces and/or torque to said handle; and
a socket within which said second end is located when the items is reconnected to the handle; and wherein said socket tapers inwardly of the handle, and said handle has an end extremity providing a surface with a radius.
